(19) United States
(12) Patent Application Publication
(10) Pub. No.: US 2013/0115803 A1
(43) Pub. Date: May 9, 2013

(54) SYSTEM AND METHOD FOR PROVIDING A VISUAL INDICATOR FOR CABLES

(71) Applicants: Norman Tang, Los Altos, CA (US); Liang Ping Peng, Santa Clara, CA (US); Anthony Nguyen, San Jose, CA (US); David Lai, Mountain View, CA (US)

(72) Inventors: Norman Tang, Los Altos, CA (US); Liang Ping Peng, Santa Clara, CA (US); Anthony Nguyen, San Jose, CA (US); David Lai, Mountain View, CA (US)

(73) Assignee: Cisco Technology, Inc.

(21) Appl. No.: 13/292,846

(22) Filed: Nov. 9, 2011

(51) Int. Cl. H01R 3/00

(52) U.S. Cl. 439/488

(57) ABSTRACT

A method is provided in one example and includes receiving a signal at an indicator activator provided on a first end of a data cable. The data cable comprises a second end that includes an indicator. The method also includes activating the indicator such that at least a portion of the data cable is illuminated. In more particular embodiments, the indicator activator is a switch, and the signal causes the switch to close such that a current is provided to the indicator.

### TECHNICAL FIELD

This disclosure relates in general to the field of communications and, more particularly, to providing a visual indicator for cables.

### BACKGROUND

Networking architectures have grown increasingly complex in communication environments. The routing and management of sessions and data flows often requires multiple pieces of computer hardware (e.g., server, router, switch, storage, etc.). The computer hardware is typically stored in a server rack, chassis, or tower server. The rack may include multiple mounting slots (sometimes referred to as bays) that are designed to hold a hardware unit securely in place. Each piece of hardware should be connected to another piece of hardware, which is typically done with high-speed cables. For systems with multiple pieces of hardware, the amount of cable used in the system can create a tangled mess of cable. The tangling issue can create a problem when the end point of each cable cannot be readily identified because of the difficultly in tracing individual cables through the nested cable jumble.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of an example data cable;

FIG. 1B is a simplified block diagram of an example octopus data cable;

FIG. 2 is a simplified schematic diagram illustrating possible example details associated with the data cable;

FIG. 3A is another simplified schematic diagram illustrating possible example details associated with the data cable;

FIG. 3B is another simplified schematic diagram illustrating possible example details associated with the data cable;

FIG. 4A is another simplified schematic diagram illustrating possible example details associated with the data cable;

FIG. 4B is another simplified schematic diagram illustrating possible example details associated with the data cable;

FIG. 5 is another simplified schematic diagram illustrating possible example details associated with the data cable;

FIG. 6 is another simplified schematic diagram illustrating possible example details associated with the data cable; and

FIG. 7 is a simplified flowchart illustrating potential operations associated with the data cable.

### DETAILED DESCRIPTION OF EXAMPLE EMBODIMENTS

### Overview

A method is provided in one example and includes receiving a signal at an indicator activator provided on a first end of a data cable. The data cable comprises a second end that includes an indicator. The method also includes activating the indicator such that at least a portion of the data cable is illuminated (e.g., the second end of the data cable is illuminated, the indicator itself is illuminated, some other portion of the data cable is illuminated, etc.). In more particular embodiments, the indicator activator is a switch, and the signal causes the switch to close such that a current is provided to the indicator. In specific instances, the indicator is a light emitting diode (LED).

In more detailed instances, the first end is a small form-factor pluggable plus (SFP+) end, the second end is a SFP+ end, and the cable is a twinaxial copper cable. In addition, the first end can be a quad small form-factor pluggable (QSFP) end, and the second end can include at least four small form-factor pluggable plus (SFP+) ends. The method can also include activating a selected one of a plurality of indicator activators on the first end, where each of the plurality of indicator activators corresponds to a unique indicator on the four SFP+ ends. In certain implementations, the selected indicator activator is activated, each of the four SFP+ ends are illuminated at a different blinking rate. In addition, activating the indicator can cause portions of the data cable to be illuminated at different illumination intensities.

### Example Embodiments

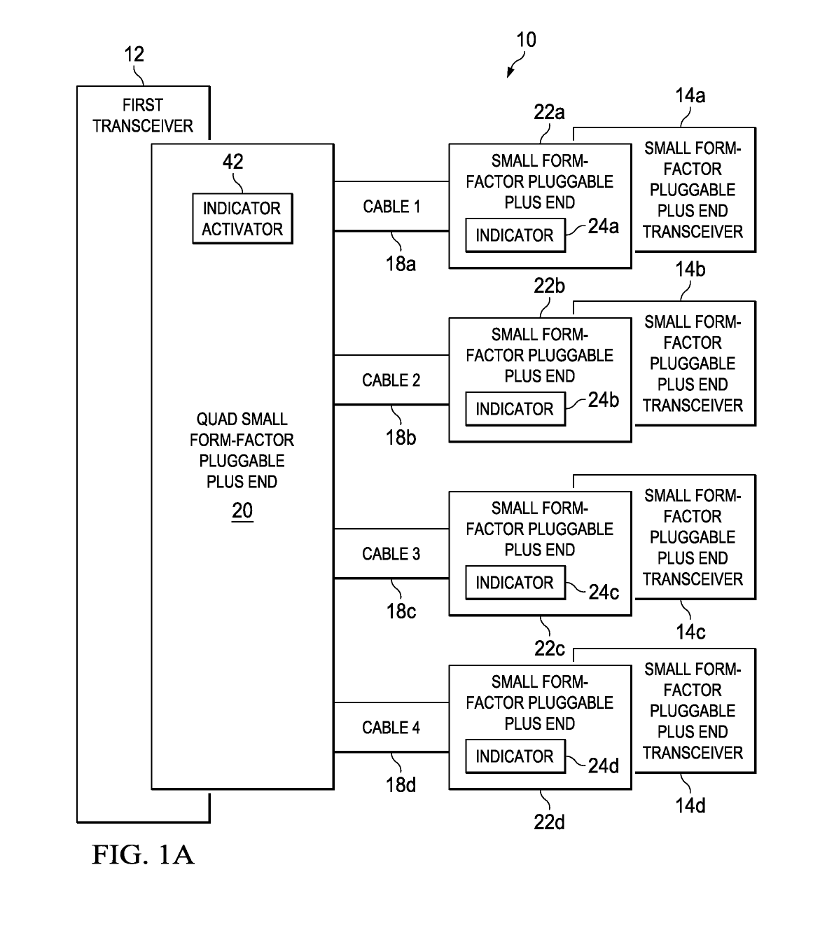

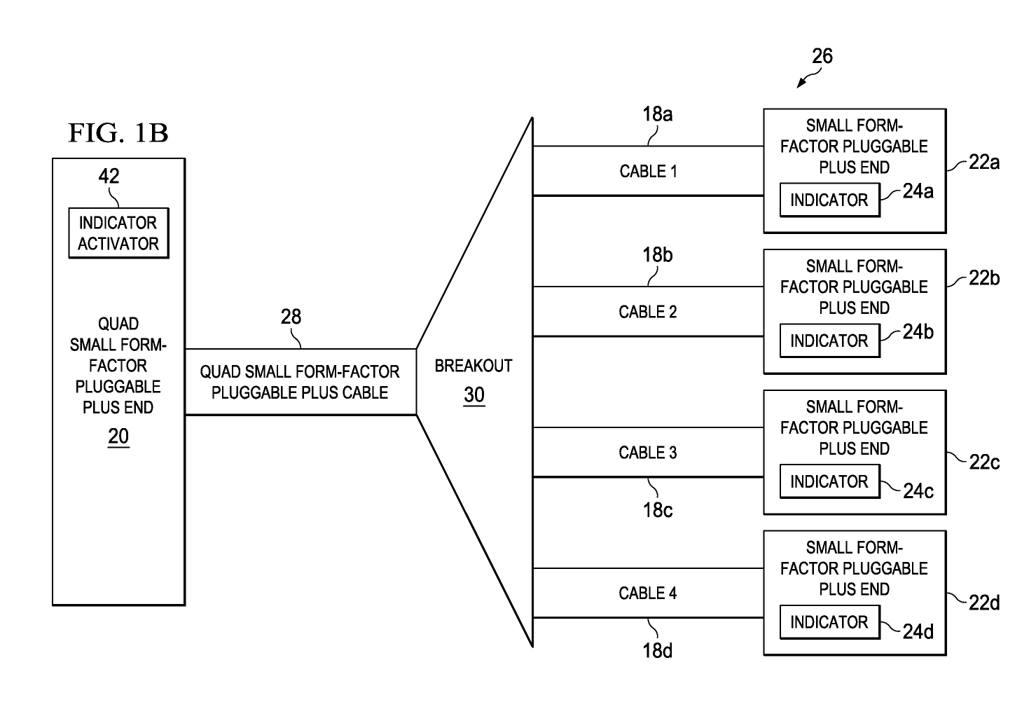

Turning to FIG. 1A, FIG. 1A is a simplified block diagram illustrating one example implementation of a data cable 10 in accordance with one embodiment of the present disclosure. Data cable 10 can be configured to allow connectivity options for a data center, enterprise wiring closet, service provider transport applications, or any other suitable application. In specific instances, data cable 10 can allow ten (10) Gigabit Ethernet connectivity options for an associated system. In another example instance, data cable 10 is a twinaxial cable. In yet another embodiment, data cable 10 may be a small form-factor pluggable plus (SFP+)/quad small form-factor pluggable (QSFP) twinaxial copper cable.

FIG. 1A includes a first transceiver 12 and a set of SFP+ end transceivers 14a-d. SFP+ end transceivers 14a-d may be one transceiver, four separate transceivers, or any combination of one or more transceivers associated with any one or more other transceivers. First transceiver 12 and SFP+ end transceivers 14a-d can operate as both a transmitter and a receiver. Data cable 10 may include a QSFP end 20, a first cable 18a, a second cable 18b, a third cable 18c, a fourth cable 18d, a first SFP+ end 22a, a second SFP+ end 22b, a third SFP+ end 22c, and a fourth SFP+ end 22d. First SFP+ end 22a may include a first SFP+ indicator 24a, second SFP+ end 22b may include a second SFP+ indicator 24b, third SFP+ end 22c may include a third SFP+ indicator 24c, and fourth SFP+ end 22d may include a fourth SFP+ indicator 24d. QSFP end 20 may include an indicator activator 42.

QSFP end 20 is configured to integrate four (4) transmit and four (4) receive channels (e.g., first cable 18a, second cable 18b, third cable 18c, and fourth cable 18d) and can also support a variety of 10 Gigabit Ethernet connectivity options (e.g., 10G Ethernet, Fiber Channel, etc.) with different data rate options. First cable 18a may extend from QSFP end 20 to first SFP+ end 22a. Second cable 18b may extend from QSFP end 20 to second SFP+ end 22b. Third cable 18c may extend from QSFP end 20 to third SFP+ end 22c. Fourth cable 18d may extend from QSFP end 20 to fourth SFP+ end 22d.

When QSFP end 20 is connected to first transceiver 12 and first SFP+ end 22a, second SFP+ end 22b, third SFP+ end 22c, and fourth SFP+ end 22d are connected to SFP+ end transceivers 14a-d respectively. First transceiver 12 and SFP+ end transceivers 14a-d can communicate with each other using first cable 18a, second cable 18b, third cable 18c, and fourth cable 18d. If QSFP end 20 is connected to first transceiver 12 and only first SFP+ end 22a is connected to SFP+ end transceiver 14a, second SFP+ end 22b is connected to SFP+ end transceiver 14b, third SFP+ end 22c is connected to SFP+ end transceiver 14c, and/or fourth SFP+ end 22d is connected to SFP+ end transceiver 14d (or any combination of a SFP+ end being connected to a SFP+ end transceiver), then first transceiver 12 and SFP+ end transceivers 14a-d can communicate with each other only using a cable associated with a connected SFP+ end. For example, if only first SFP+ end 22a is connected to SFP+ end transceivers 14a (and QSFP end 20 is connected to first transceiver 12), then first transceiver 12 and SFP+ end transceiver 14a can communicate with each other only using first cable 18a. Because second SFP+ end 22b, third SFP+ end 22c, and fourth SFP+ end 22d are not connected to SFP+ end transceivers 14b-d, first transceiver 12 cannot communicate with SFP+ end transceivers 14b-d using second cable 18b, third cable 18c, or fourth cable 18d.

First SFP+ indicator 24a, second SFP+ indicator 24b, third SFP+ indicator 24c, and fourth SFP+ indicator 24d are configured to provide an indication that may allow a user to identify first SFP+ end 22a, second SFP+ end 22b, third SFP+ end 22c, and fourth SFP+ end 22d respectively. For example, first SFP+ indicator 24a, second SFP+ indicator 24b, third SFP+ indicator 24c, and fourth SFP+ indicator 24d may each be a light emitting diode (LED). Each indicator may be activated individually or as a group. For example, first SFP+ indicator 24a may blink fast then slow to identify first SFP+ end 22a, second SFP+ indicator 24b may blink fast, fast, then slow to identify second SFP+ end 22b, third SFP+ indicator 24c may blink fast, fast, fast, then slow to identify third SFP+ end 22c, and fourth SFP+ indicator 24d may blink fast, fast, fast, fast, then slow to identify fourth SFP+ end 22d.

In other embodiments, each indicator may have a unique color (e.g., first SFP+ indicator 24a may be red, second SFP+ indicator 24b may be yellow, etc.), have a unique number of indicators (e.g., first SFP+ indicator 24a may have one LED, second SFP+ indicator 24b may have two LEDs, etc.), have a unique shape, have a unique blinking rate, have a unique illumination intensity, or any other differentiation quality that would help identify a specific SFP+ end. Power for first SFP+ indicator 24a, second SFP+ indicator 24b, third SFP+ indicator 24c, and fourth SFP+ indicator 24d can be supplied from first transceiver 12 when QSFP end 20 is connected to first transceiver 12 (i.e., current flows from first transceiver 12, across QSFP end 20, over first cable 18a, second cable 18b, third cable 18c, and fourth cable 18d, to first SFP+ indicator 24a, second SFP+ indicator 24b, third SFP+ indicator 24c, and fourth SFP+ indicator 24d respectively). In one particular instance, first transceiver 12 and SFP+ end transceivers 14a-d can be associated with an enterprise or data center deployment that has short (or limited) reach interconnections.

Turning to FIG. 1B, FIG. 1B is a simplified block diagram illustrating one example implementation of an octopus cable 26. Octopus cable 26 is somewhat similar in form and function to data cable 10, except octopus cable 26 may offer different features, as detailed below. In a general sense, octopus cable 26 is a cable that is spliced into several branches. Octopus cable 26 may include a connector on one end and multiple connectors on the other, as is illustrated in FIG. 1B.

In this particular example implementation, octopus cable 26 may include QSFP end 20, a QSFP cable 28, a breakout 30, first cable 18a, second cable 18b, third cable 18c, fourth cable 18d, first SFP+ end 22a, second SFP+ end 22b, third SFP+ end 22c, and fourth SFP+ end 22d. First SFP+ end 22a may include first SFP+ indicator 24a, second SFP+ end 22b may include second SFP+ indicator 24b, third SFP+ end 22c may include third SFP+ indicator 24c, and fourth SFP+ end 22d may include fourth SFP+ indicator 24d. QSFP end 20 may include an indicator activator 42. Breakout 30 separates QSFP cable 28 into first cable 18a, second cable 18b, third cable 18c, and fourth cable 18d. Alternatively, breakout 30 joins first cable 18a, second cable 18b, third cable 18c, and fourth cable 18d into QSFP cable 28. Octopus cable 26 is configured to integrate four (4) transmit and four (4) receive channels and can support a variety of 10 Gigabit Ethernet connectivity options (e.g., 10G Ethernet, Fiber Channel, etc.) with different data rate options.

For purposes of illustrating certain example techniques of data cable 10 and octopus cable 28, the following foundational information may be viewed as a basis from which the present disclosure may be properly explained. As networks become larger with growing port density, the demand for acceptable cable management becomes apparent. This issue is even more prominent when attempting to identify a particular cable (e.g., in the context of troubleshooting, repairing a system, testing, etc.). For example, one of the solutions to increase faceplate density is to utilize a data cable or an octopus cable, such as a quad small form-factor pluggable to four small form-factor pluggable plus (QSFP to 4×SFP+) or an active CXP to twelve SFP+ end (CXP to 12×SFP+), (i.e., to fan-out the 40G (QSFP) or 120G (CXP) port to N×10G ports). If multiple cables are employed, there is a challenge in identifying the proper SFP+ end and its associated QSFP end. The challenge becomes even more difficult when multiple data cables (or octopus cables) are haphazardly bundled. Making this problem even more pejorative, labels on each cable may not be visible, obstructed from view, or simply inaccurate.

In accordance with one example implementation of the present disclosure, data cable 10 and octopus cable 26 can resolve the aforementioned issues associated with identifying specific ends. More specifically, data cable 10 and octopus cable 26 may include an indicator (e.g., a visual indicator, an audible indicator, a vibrational indicator, etc.) that is integrated into the QSFP or SFP+ end cable assemblies. The indicator can allow a user (i.e., installer, operator, etc.) to identify the correct SFP+ ends via the indicator (e.g., LED visual indicator). The indicator may become active with a press of a button or activation of a switch (i.e., indicator activator 42) on QSFP end 20. Once the indicator is active, a specific SFP+ end may be easily located such that the correct SFP+ end can be selected in a crowed cabling environment.

For example, a specific SFP+ end of data cable 10 or octopus cable 26 (e.g., QSFP-CR4 and CXP-CR12) or a remote end of a straight SFP+ end cable assembly (CR1) may be identified via a visual LED indicator. In an example embodiment, data cable 10 or octopus cable 26 may be passive and have four (4) independent switches in indicator activator 42 to control a respective indicator (e.g., first SFP+ indicator 24a) on a SFP+ end side (e.g., first SFP+ 22a). Only the near-end QSFP/CXP assembly would need to be plugged into the cage to provide power to the far-end SFP+ indicator. Upon activation of one of the four (4) independent switches, a corresponding indicator on a SFP+ end can become activated, thus allowing for an effective identification of a specific SFP+ end.

In another example, data cable 10 or octopus cable 26 may be active and indicator activator 42 may be a single switch on the QSFP/CXP assembly to control the indicators (or a specific indicator) on each SFP+ end. An electronic signal or command via an I2C interface received at a controller may also be used to control all (or a specific indicator) on each SFP+ end. In one embodiment (after activation), each indicator on each SFP+ end may blink at different rates to indicate a specific SFP+ end. For example, fast, slow for a first SFP+ end; fast, fast, slow for a second SFP+ end; fast, fast, fast, slow for a third SFP+ end; and fast, fast, fast, fast, slow for a fourth SFP+ end. Each indicator may be automatically shut off after a predetermined amount of time (e.g., 5 minutes) by the controller. In another embodiment, indicator activator 42 may be a four way switch that allows for activation of only one specific indicator. Only the near-end QSFP/CXP assembly have to be plugged in (e.g., into a cage, rack, housing, etc.) to provide power to each indicator. Upon activation of indicator activator 42, all of the indicators or only a specific indicator on a SFP+ end can become activated, thus allowing for identification of a specific SFP+ end.

In another embodiment, a passive or an active CX1 cable (i.e., a cable with an SFP+ end on both sides) may have an indicator activator and a corresponding indicator available on either end of data cable 10. Activation of the indicator activator on one end would cause the indicator on the other end of data cable 10 to become active. In one embodiment, the activate indicator may be automatically shut off after a predetermined amount of time (e.g., 5 minutes). An electronic signal or command via an I2C interface received at a controller may also be used to control all or a specific indicator on each SFP+ end. Only the near-end SFP+ end assembly have to be plugged into the cage to provide power to the far-end SFP+ end.

In various operational configurations, different types of visual indicator schemes are possible, which may depend on the type of data cable 10 or octopus cable 26. In an example embodiment, for passive QSFP to 4×SFP+ or CXP to 12×SFP+ straight or octopus cables, indicator activators (i.e., switches) on the QSFP assembly can be used to identify a specific SFP+ end by activation of an indicator on the specific SFP+ end. For example, an indicator activator corresponding to a first cable can activate an indicator on the SFP+ end that corresponds to the first cable.

In another embodiment, for active QSFP to 4×SFP+ or CXP to 12×SFP+ cable 10 or octopus cable 26, a single switch on the QSFP end can activate one or more indicators on the SFP+ end(s) to enable identification of a specific SFP+ end assembly (e.g., a single indicator on a specific SFP+ end is activated, or all indicators are activated with each having a unique blinking frequency). For example, all the indicators may be activated or a specific indicator for a specific SFP+ end may be activated. An auto shut off may terminate the activation of the indicator.

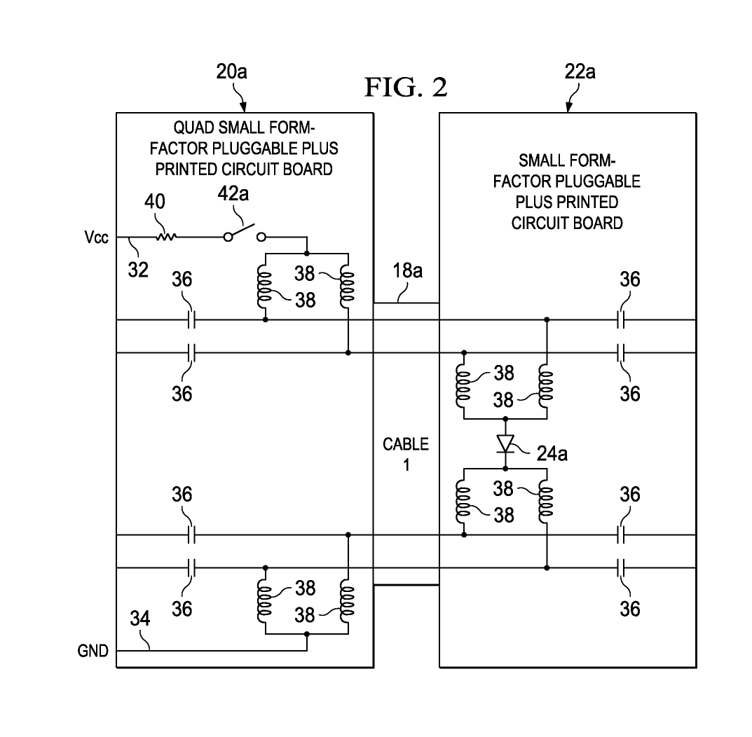

Turning to FIG. 2, FIG. 2 is a simplified schematic diagram illustrating one possible set of details associated with data cable 10. [Note that the circuits discussed with reference to data cable 10 would equally apply to octopus cable 26, or to any other cable arrangement.] In an example embodiment, data cable 10 is a passive twinaxial copper cable and, further, does not contain any active components. [Note that another example of an active twinaxial copper cable is detailed below.] FIG. 2 includes QSFP end 20a, first cable 18a, and first SFP+ end 22a. In a particular example of FIG. 2, QSFP end 20a includes a voltage input 32, a ground 34, capacitors 36, inductors 38, a resistor 40, and an indicator activator 42a. In an example embodiment, indicator activator 42a is a switch. First SFP+ end 22a includes capacitors 36, inductors 38, and first SFP+ indicator 24a.

When QSFP end 20a is connected to first transceiver 12 (e.g., using a QSFP housing), current flows through voltage input 32 and resistor 40, but the current cannot flow through the rest of the circuit. When indicator activator 42a is activated (e.g., a switch is closed), current is permitted to flow through the circuit, across first cable 18a, and first SFP+ indicator 24a is activated. For example, if first SFP+ indicator 24a is a LED, then the LED may begin to glow.

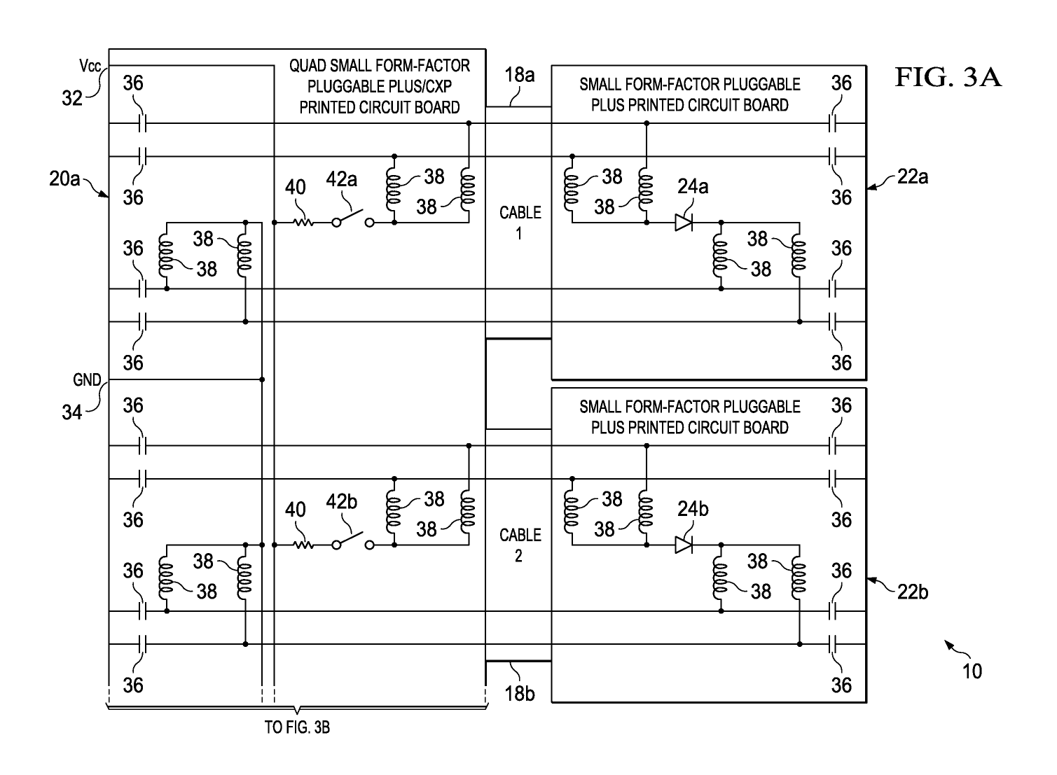

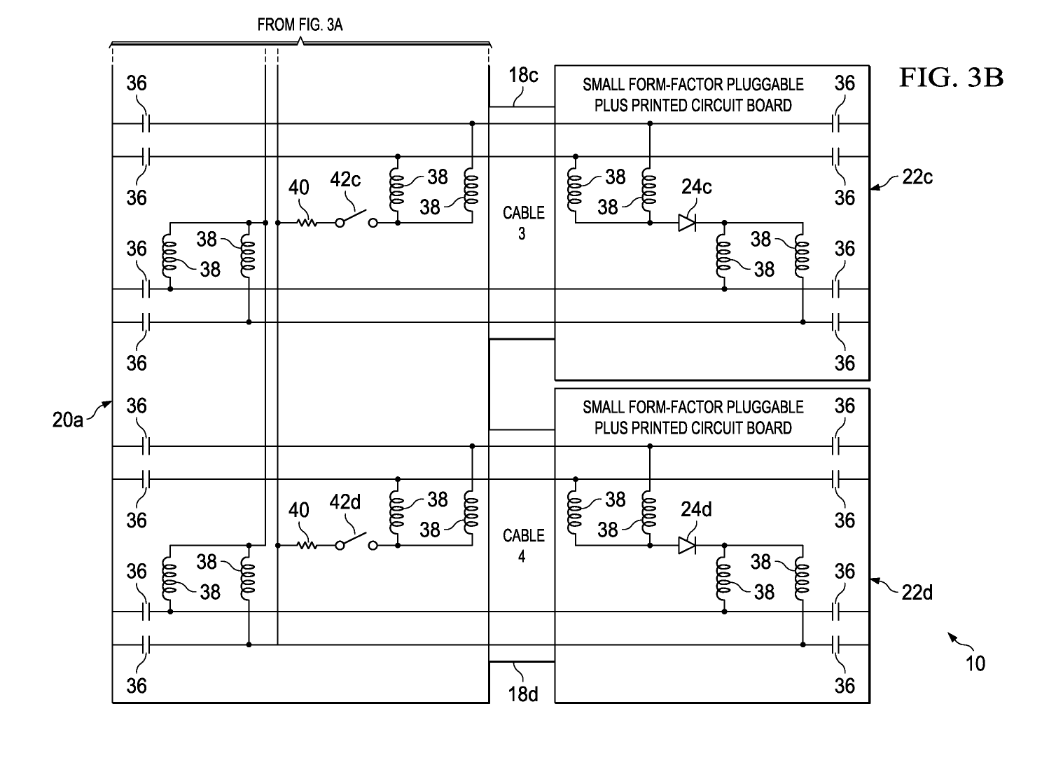

Turning to FIG. 3A, FIG. 3A is a simplified schematic diagram illustrating one possible set of details associated with a first portion of data cable 10 (FIG. 3B illustrates one possible set of details associated with a second portion of data cable 10). In an example embodiment, data cable 10 illustrated in FIGS. 3A and 3B is a passive twinaxial copper cable and does not include any active components. FIG. 3A includes QSFP end 20a, first cable 18a, second cable 18b, first SFP+ end 22a and second SFP+ end 22b.

In a particular example of FIG. 3A, QSFP end 20a includes voltage input 32, ground 34, capacitors 36, inductors 38, resistors 40, indicator activator 42a, and indicator activator 42b. In an example embodiment, indicator activator 42a and indicator activator 42b are switches. First SFP+ end 22a includes capacitors 36, inductors 38, and first SFP+ indicator 24a. Second SFP+ end 22b includes capacitors 36, inductors 38, and second SFP+ indicator 24b.

Before discussing the operation details of FIG. 3A, and because of the interrelationship between FIG. 3A and FIG. 3B, FIG. 3B is introduced. FIG. 3B is a simplified schematic diagram illustrating one possible set of details associated with the second portion of data cable 10. FIG. 3B includes QSFP end 20a, third cable 18c, fourth cable 18d, third SFP+ end 22c and fourth SFP+ end 22d. In a particular example of FIG. 3B, QSFP end 20a includes capacitors 36, inductors 38, resistors 40, an indicator activator 42c, and an indicator activator 42d. In an example embodiment, indicator activator 42c and indicator activator 42d are switches. Third SFP+ end 22c includes capacitors 36, inductors 38, and third SFP+ indicator 24c. Fourth SFP+ end 22d includes capacitors 36, inductors 38, and fourth SFP+ indicator 24d. Voltage input 32 and ground 34 shown in FIG. 3A are electrically connected to the electrical components shown in FIG. 3B.

In one example illustration, when QSFP end 20a is connected to first transceiver 12, current flows through voltage input 32 and each resistor 40, but it cannot flow through the rest of the circuit. When indicator activator 42a is activated (e.g., a switch is closed), current is allowed to flow through a portion of the circuit, across first cable 18a, and first SFP+ indicator 24a is activated (e.g., if first SFP+ indicator 24a is a LED, then the LED may begin to glow). Similarly, when indicator activator 42b is activated, current is allowed to flow through a portion of the circuit, across second cable 18b, and second SFP+ indicator 24b is activated (e.g., if second SFP+ indicator 24b is a LED, then the LED may begin to glow). Also, when indicator activator 42c is activated, current is allowed to flow through a portion of the circuit, across third cable 18c, and third SFP+ indicator 24c is activated (e.g., if third SFP+ indicator 24c is a LED, then the LED may begin to glow). In addition, when indicator activator 42d is activated, current is allowed to flow through a portion of the circuit, across fourth cable 18d, and fourth SFP+ indicator 24d is activated (e.g., if fourth SFP+ indicator 24d is a LED, then the LED may begin to glow). By selectively activating either first SFP+ indicator 24a, second SFP+ indicator 24b, third SFP+ indicator 24c, or fourth SFP+ indicator 24d, a user (e.g., installer or operator) may be able to identify a specific SFP+ end (i.e., either SFP+ end 22a, SFP+ end 22b, SFP+ end 22c, or SFP+ end 22d) without having to trace or follow first cable 18a, second cable 18b, third cable 18c, or fourth cable 18d.

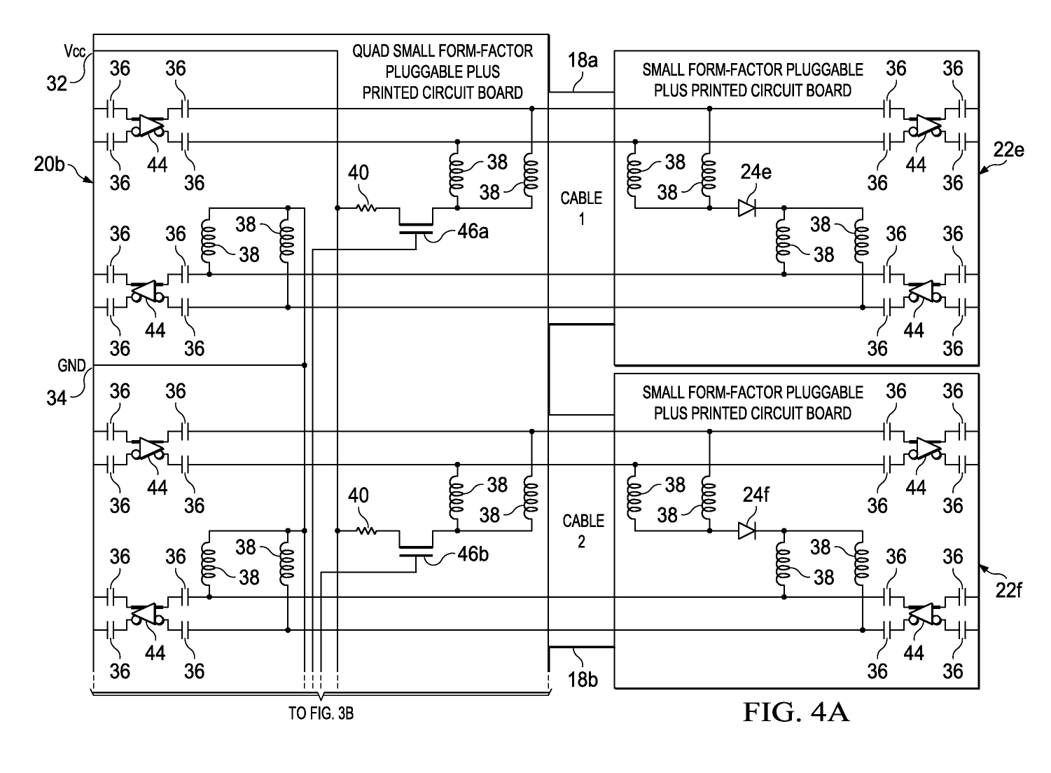

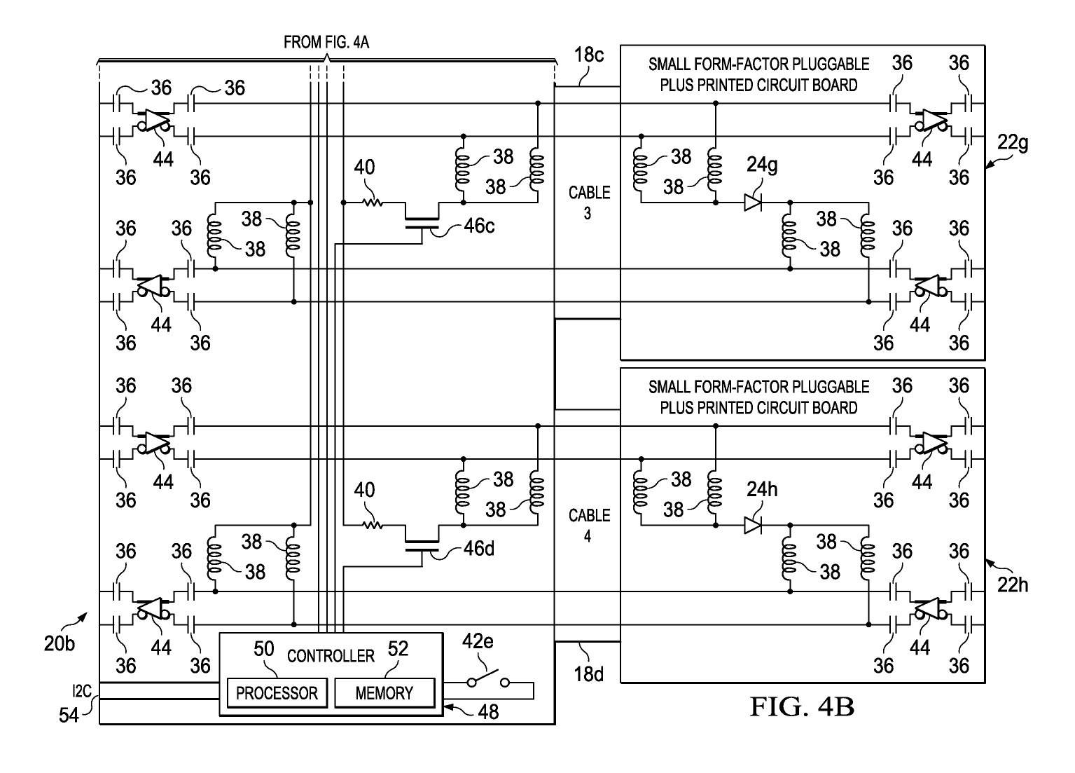

Turning to FIG. 4A, FIG. 4A is a simplified schematic diagram illustrating one possible set of details associated with a first portion of data cable 10 (FIG. 4B illustrates one possible set of details associated with a second portion of data cable 10). In an example embodiment, data cable 10 illustrated in FIGS. 4A and 4B is an active twinaxial copper cable and may include active components. FIG. 4A includes QSFP end 20b, first cable 18a, second cable 18b, first active SFP+ end 22e, and second active SFP+ end 22f. In a particular example of FIG. 4A, QSFP end 20b includes voltage input 32, ground 34, capacitors 36, inductors 38, resistors 40, a signal driver 44 (e.g., clock and data recovery (CDR)), first active switch 46a (e.g., metal-oxide-semiconductor field-effect transistor (MOSFET)), and second active switch 46b (e.g., MOSFET). First active SFP+ end 22e includes capacitors 36, inductors 38, signal driver 44, and first active SFP+ indicator 24e. Second active SFP+ end 22f includes capacitors 36, inductors 38, signal driver 44, and second active SFP+ indicator 24f.

FIG. 4B is a simplified schematic diagram illustrating one possible set of details associated with the second portion of data cable 10. FIG. 4B includes QSFP end 20b, third cable 18c, fourth cable 18d, third active SFP+ end 22g, and fourth active SFP+ end 22h. In a particular example of FIG. 4B, QSFP end 20b includes capacitors 36, inductors 38, resistors 40, signal driver 44 (e.g., CDR), third active switch 46c (e.g., MOSFET), fourth active switch 46d (e.g., MOSFET), a controller 48, an I2C input 54, and an indicator activator 42e. In an example embodiment, indicator activator 42e may be a mechanical switch (e.g., dual in-line package (DIP) switch, four way switch, etc.). I2C 54 is a multi-master serial single-ended computer bus that uses two bidirectional open-drain lines. Controller 48 may include a processor 50 and a memory 52. Third active SFP+ end 22g includes capacitors 36, inductors 38, signal driver 44, and a third active SFP+ indicator 24g. Fourth active SFP+ end 22h includes capacitors 36, inductors 38, signal driver 44, and a fourth active SFP+ indicator 24h.

Voltage input 32 and ground 34 (shown in FIG. 4A) are electrically connected to the electrical components shown in FIG. 4B. Controller 48 is electrically connected to (and is configured to control) first active switch 46a, second active switch 46b, third active switch 46c, and fourth active switch 46d.

In one example illustration, when QSFP end 20b is connected to first transceiver 12, current flows through voltage input 32 and resistors 40, but it cannot flow through the rest of the circuit. If indicator activator 42e is positioned to close first active switch 46a, current is allowed to flow through a portion of the circuit, across first cable 18a, and first active SFP+ indicator 24e is activated (e.g., if first active SFP+ indicator 24e is a LED, then the LED may glow). Similarly, when indicator activator 42e is positioned to close second active switch 46b, current is allowed to flow through a portion of the circuit, across second cable 18b, and second active SFP+ indicator 24f is activated (e.g., if second active SFP+ indicator 24f is a LED, then the LED may begin to glow). Also, when indicator activator 42e is positioned to close third active switch 46c, current is allowed to flow through a portion of the circuit, across third cable 18c, and third active SFP+ indicator 24g is activated (e.g., if third active SFP+ indicator 24g is a LED, then the LED may begin to glow). In addition, when indicator activator 42e is positioned to close fourth active switch 46d, current is allowed to flow through a portion of the circuit, across fourth cable 18d, and fourth active SFP+ indicator 24h is activated (e.g., if fourth active SFP+ indicator 24h is a LED, then the LED may begin to glow).

Indicator activator 42e (through controller 48) may be configured to close first active switch 46a, second active switch 46b, third active switch 46c, and fourth active switch 46d individually or simultaneously. By selectively activating either first SFP+ indicator 24e, second active SFP+ indicator 24f, third active SFP+ indicator 24g, or fourth active SFP+ indicator 24h, or (if all indicators are activated simultaneously) by causing each indicator to blink or glow at a unique pattern or frequency, a user (e.g., installer or operator) may be able to identify a specific SFP+ end (i.e., either first active SFP+ end 22e, second active SFP+ end 22f, third active SFP+ end 22g, or fourth active SFP+ end 22h) without having to trace or follow first cable 18a, second cable 18b, third cable 18c, or fourth cable 18d.

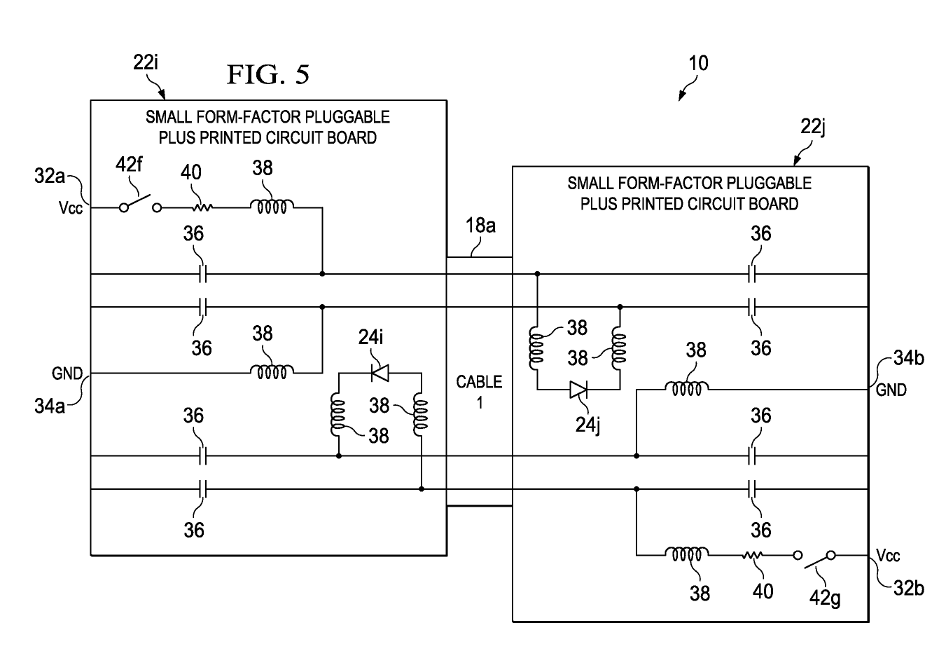

Turning to FIG. 5, FIG. 5 is a simplified schematic diagram illustrating one possible set of details associated with data cable 10. In an example embodiment, data cable 10 is a passive twinaxial cable with two SFP+ ends, where the cable is integrated into the SFP+ end (e.g., CX-1 cables). FIG. 5 includes fifth SFP+ end 22i, first cable 18a, and sixth SFP+ end 22j. In a particular example of FIG. 5, fifth SFP+ end 22j includes voltage input 32a, ground 34a, capacitors 36, inductors 38, resistor 40, indicator activator 42f, and indicator 24i. In an example embodiment, indicator activator 42f is a switch. Sixth SFP+ end 22j includes voltage input 32b, ground 34b, capacitors 36, inductors 38, resistor 40, indicator activator 42g, and sixth SFP+ indicator 24j. In an example embodiment, indicator activator 42g is a switch.

When fifth SFP+ end 22i is connected to first transceiver 12 (e.g., using a SFP+ end housing), current flows through voltage input 32a, but it cannot flow through the rest of the circuit. When indicator activator 42f is activated, current is allowed to flow through the circuit, across first cable 18a, and sixth SFP+ indicator 24j is activated. For example, if sixth SFP+ indicator 24j is a LED, then the LED may begin to glow. Sixth SFP+ end 22j does not need to be connected to second transceiver 14.

When sixth SFP+ end 22j is connected to second transceiver 14 (e.g., using a SFP+ end housing), current flows through voltage input 32b, but it cannot flow through the rest of the circuit. When indicator activator 42g is activated, current is allowed to flow through the circuit, across first cable 18a, and fifth SFP+ indicator 24i is activated. For example, if fifth SFP+ indicator 24i is a LED, then the LED may begin to glow. Fifth SFP+ end 22i does not need to be connected to first transceiver 12.

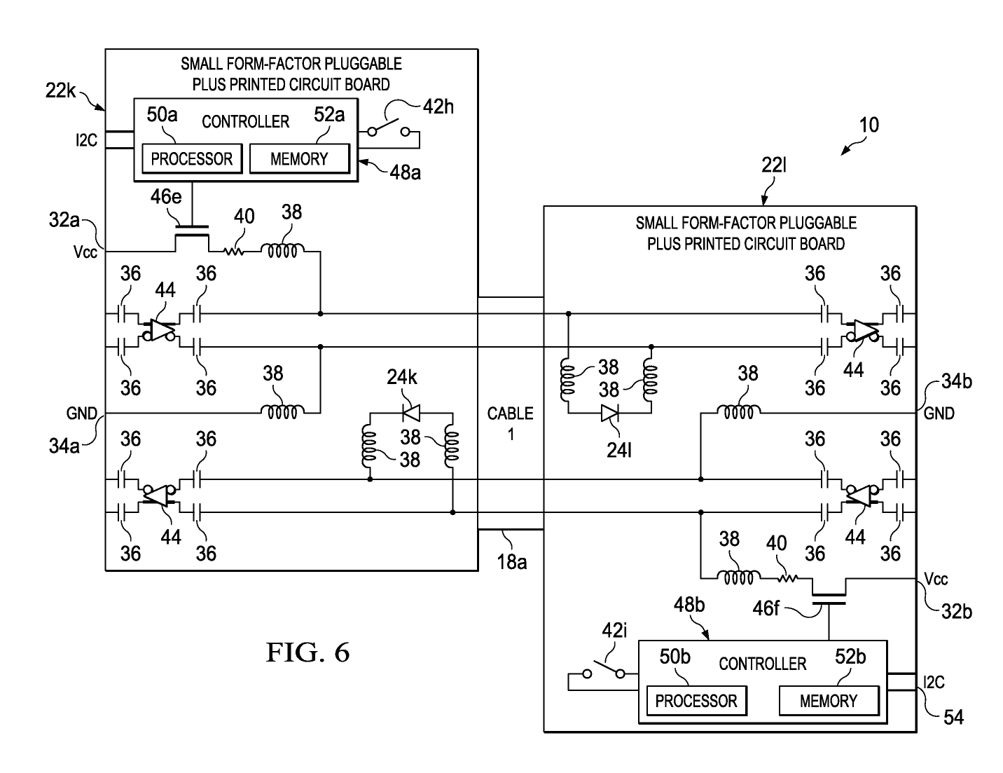

Turning to FIG. 6, FIG. 6 is a simplified schematic diagram illustrating one possible set of details associated with data cable 10. In an example embodiment, data cable 10 is an active twinaxial cable with two SFP+ ends, where the cable is integrated into the SFP+ ends (e.g., CX-1 cables). Data cable 10 includes fifth active SFP+ end 22k, first cable 18a, and sixth active SFP+ end 22l. In a particular example of FIG. 6, fifth active SFP+ end 22k includes voltage input 32a, ground 34a, capacitors 36, inductors 38, resistor 40, signal drivers 44 (e.g., CDR), fifth active switch 46e (e.g., MOSFET), controller 48a, indicator activator 42h, I2C 54, and fifth active SFP+ indicator 24k. Controller 48a includes processor 50a and memory 52a. Sixth active SFP+ 22l may include capacitors 36, inductors 38, signal driver 44, sixth active switch 46f, controller 48b, indicator activator 42i, I2C input 54, and sixth active SFP+ indicator 24l. Controller 48b may include processor 50b and memory 52b.

When fifth active SFP+ end 22k is connected to first transceiver 12 (e.g., using a SFP+ end housing), current flows through voltage input 32a, but it cannot flow through the rest of the circuit. When indicator activator 42h is activated, current is allowed to flow through the circuit, across first cable 18a, and sixth active SFP+ indicator 24l is activated. For example, if sixth active SFP+ indicator 24l is a LED, then the LED may begin to glow. Sixth active SFP+ end 22l does not need to be connected to any one of SFP+ end transceivers 14a-d.

When sixth active SFP+ end 22l is connected to second transceiver 14 (e.g., using a SFP+ end housing), current flows through voltage input 32b, but it cannot flow through the rest of the circuit. When indicator activator 42i is activated, current is allowed to flow through the circuit, across first cable 18a, and indicator 24k is activated. For example, if indicator 24k is a LED, then the LED may begin to glow. Fifth active SFP+ end 22k does not need to be connected to first transceiver 12.

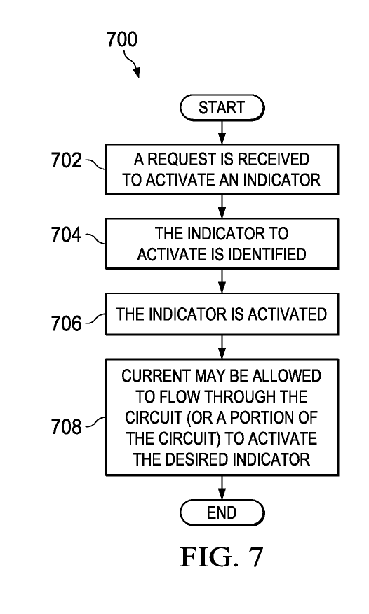

FIG. 7 is a simplified block diagram illustrating one potential operation associated with the present disclosure. At 702, a signal is received to activate an indicator. For example, the request may be received by the activation of indicator activator 42a-i. The signal itself can include any suitable request, software trigger, hardware trigger (e.g., pressing a button coupled to the indicator activator), etc. If activation indicator 42a-11s a switch, then the switch may be closed (e.g., by pressing a button coupled to the switch, or that surrounds the switch, etc.). Note that the activation indicator can be any suitable mechanism that can trigger, or otherwise foster a signal being provided to the indicator. This includes any suitable circuitry, hardware, software, button configuration, etc.

At 704, the actual indicator is identified, where this indicator is used to activate some identification property for the cable. For example, in an active cable, a single indicator activator (e.g., indicator activator 42e) may be used to activate a single indicator, which provides some type of illumination. This illumination may include any suitable lighting mechanism, light energy, LED configuration, etc. In certain instances, the illumination may be powered by closing a switch such that a circuit is completed, or the illumination may be powered by solar energy, powered by some type of battery configuration, or powered by any other suitable power source.

Controller 48 may be used to determine which indicator to activate based on the position of the indicator activator. In another example, controller 48 may process a signal received from I2C input 54 to determine which indicator to activate. At 706, the indicator is activated. At 708, current may be allowed to flow through the circuit (or a portion of the circuit) to activate the desired indicator. In one particular example, the current is allowed to flow through the entire circuit such that all the indicators are active (where each indicator gives a unique identification for each SFP+ end). In another particular example, only one indicator is activated.

Note that in certain example implementations, the functions outlined herein may be implemented by non-transitory logic encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element [as shown in FIGS. 4B and 6] can store data used for the operations described herein. This includes the memory element being able to store code (e.g., software, logic, or processor instructions) executed to carry out the activities described in this Specification. A processor can execute any type of code associated with the data to achieve the operations detailed herein in this Specification. In one example, the processor [as shown in FIGS. 4B and 6] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Note that with the examples provided above, as well as numerous other examples provided herein, interaction may be described in terms of two, three, or four electrical components (i.e., capacitors 36, inductors 38, resistors 40, etc.). However, this has been done for purposes of clarity and example only. In certain cases, it may be easier to describe one or more of the functionalities of a given set of flows by only referencing a limited number of electrical components. It should be appreciated that data cable 10 and octopus cable 26 (and their teachings) are readily scalable and can accommodate a large number of components, as well as more complicated/sophisticated arrangements and configurations. Accordingly, the examples provided should not limit the scope or inhibit the broad teachings of data cable 10 and octopus cable 26, as potentially applied to a myriad of other architectures. Any cable can benefit from the teachings of the present disclosure. The cable can include any type of wire configuration, and any type of conducive material for propagating data, energy, light, etc. This would include computer applications, lighting fixtures (e.g., lamps, track lighting, etc.), residential appliance configurations, enterprise applications (e.g., server farms, wiring closets, HVAC systems, etc.). Virtually any cable type could be used in conjunction with the present disclosure.

It is also important to note that the steps in the preceding flow diagrams illustrate only some of the possible signaling scenarios and patterns that may be executed by, or within, data cable 10 and octopus cable 26. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by data cable 10 and octopus cable 26 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular exchanges involving certain electrical components, data cable 10 and octopus cable 26 may be applicable to other cable arrangements. Moreover, the present disclosure is equally applicable to various technologies, aside from the disclosed architectures, as these have only been offered for purposes of discussion.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a signal at an indicator activator provided on a first end of a data cable, wherein the data cable comprises a second end that includes an indicator; and
activating the indicator such that at least a portion of the data cable is illuminated.

2. The method of claim 1, wherein the indicator activator is a switch, and wherein the signal causes the switch to close such that a current is provided to the indicator.

3. The method of claim 1, wherein the first end is a small form-factor pluggable plus (SFP+) end, the second end is a SFP+ end, and the data cable is a twinaxial copper cable.

4. The method of claim 1, wherein the first end is a quad small form-factor pluggable (QSFP) end, and the second end comprises at least four small form-factor pluggable plus (SFP+) ends.

5. The method of claim 4, further comprising:
activating a selected one of a plurality of indicator activators on the first end, wherein each of the plurality of indicator activators corresponds to a unique indicator on the four SFP+ ends.

6. The method of claim 4, wherein when the selected indicator activator is activated, each of the four SFP+ ends are illuminated at a different blinking rate.

7. The method of claim 1, wherein activating the indicator causes portions of the data cable to be illuminated at different illumination intensities.

8. Logic encoded in non-transitory media that includes code for execution and when executed by a processor operable to perform operations, comprising:
receiving a signal at an indicator activator provided on a first end of a data cable, wherein the data cable comprises a second end that includes an indicator; and
activating the indicator such that at least a portion of the data cable is illuminated.

9. The logic of claim 8, wherein the indicator activator is a switch, and wherein the signal causes the switch to close such that a current is provided to the indicator.

10. The logic of claim 8, the operations further comprising:
activating a selected one of a plurality of indicator activators on the first end, wherein each of the plurality of indicator activators corresponds to a unique indicator.

11. The logic of claim 10, wherein when the selected indicator activator is activated, respective ends of the data cable are illuminated at different blinking rates.

12. The logic of claim 10, wherein when the selected indicator activator is activated, respective ends of the data cable are illuminated at different illumination intensities.

13. A cable, comprising:
a first end that includes an indicator activator; and
a second end that includes an indicator, wherein activating the indicator causes at least a portion of the cable to be illuminated.

14. The cable of claim 13, wherein the indicator activator is a switch, and wherein the signal causes the switch to close such that a current is provided to the indicator.

15. The cable of claim 13, wherein the first end is a small form-factor pluggable plus (SFP+) end, the second end is a SFP+ end, and the cable is a twinaxial copper cable.

16. The cable of claim 13, wherein the first end is a quad small form-factor pluggable (QSFP) end, and the second end comprises at least four small form-factor pluggable plus (SFP+) ends.

17. The cable of claim 16, wherein when a selected one of a plurality of indicator activators is activated, each of the four SFP+ ends are illuminated at a different blinking rate.

18. The cable of claim 13, wherein each of a plurality of indicator activators on the first end corresponds to a unique indicator.

19. The cable of claim 13, wherein activating the indicator causes portions of the cable to be illuminated at different illumination intensities.

20. The cable of claim 13, wherein the cable is an active quad small form-factor pluggable to four small form-factor pluggable plus (QSFP to 4×SFP+), or an active CXP to twelve SFP+ end (CXP to 12×SFP+).
